(19) United States
(12) Patent Application Publication
(10) Pub. No.: US 2009/0221819 A1
(43) Pub. Date: Sep. 3, 2009

(54) FLUORESCENT COMPOUNDS AND USE OF SAID COMPOUNDS IN MULTIPHOTON METHODS OR DEVICES

(76) Inventors: Mireille Blanchard-Desce, Rennes (FR); Laurent Porres, Bordeaux (FR); Olivier Mongin, Rennes (FR); Celine Le Droumaguet, Plouec du Trieux (FR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/159,471

(22) PCT Filed: Dec. 29, 2006
(86) PCT No.: PCT/EP2006/070274

§ 371 Date: Sep. 19, 2008

(30) Foreign Application Priority Data
Dec. 29, 2005 (FR) 0513474

(51) Int. Cl. C07F 5/02

(52) U.S. Cl. 544/229

(57) ABSTRACT

The invention relates to a chemical compound with an effective double photon absorbance section of greater than 50 GM, preferably greater than 100 GM, for at least one wavelength in the range 700-1200 nm, characterised in being made up of a core with double photon absorption properties connected by separate covalent bonds to at least two boron dipyrromethene type emitters of formula (—BDP) (I): where one of R¹ to R⁷ represents a covalent bond to said core, the others being identical or different each representing a group from H, C₁-C₂₅ alkyl, preferably C₁-C₁₂, (CH₂)ₘ—SO₃M, (CH₂)ₘNAlk₃⁺, (CH₂)m-(OCH₂—CH₂)ₚ—OH, where M=an alkaline metal and m=0 or a whole number from 1 to 12 inclusive, preferably between 1 and 6, p=a whole number between 1 and 25 inclusive, aryl, heteroaryl, arylethenyl or arylethynyl.

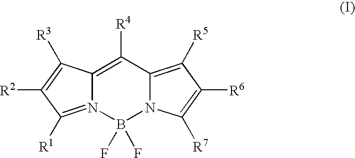

The invention relates to the field of design and production of fluorescent compounds (“fluorophores”) having properties making them capable of being implemented in multiphoton processes and devices and in particular biophotonic processes and devices.

The study of the main cellular functions such as, for example, genome expression, membrane trafficking and the study of the cell mobility and cellular organization of tissues make it necessary to localize, measure and quantify, in vivo, at the microscopic and nanoscopic scale, the dynamics and interactions between molecules of biological interest (proteins, nucleic acids, lipids, ions, etc.).

Although classic fluorescence microscopy, which implements markers (fluorophores) excitable by single-photon excitation, is a powerful tool for imaging of living matter, it has nevertheless a number of drawbacks, limiting its benefit in this field of application.

First, it often implements probes excitable in the ultraviolet range or in the blue portion of the visible spectrum. Such an excitation in this field can be toxic for living tissue.

Second, it allows only an observation of limited depth in the living tissue due to the greater diffusion of visible light than infrared light, and the intrinsic absorption of biomolecules.

Third, it can induce endogenous fluorescence of living tissue, which interferes with the observation.

Multiphoton microscopy makes it possible to overcome these problems by the two-photon excitation fluorescence technique (hereinafter sometimes referred to as “TPEF”).

This technique is based on the concept that certain atoms or molecules can simultaneously absorb two photons. This two-photon absorption property (hereinafter sometimes referred to as “TPA”) of certain molecules is characterized by their effective TPA cross-section, denoted σ₂.

Thus, certain fluorescent molecules (fluorophores) excitable by a photon of energy hν and of wavelength λ are also capable of being excited simultaneously by two photons of energy hν/2 and of wavelength 2λ. A single-photon excitation in the UV range-blue portion of the visible spectrum can thus be replaced by a biphotonic excitation in the red-near infrared range, which is non-toxic for living tissue and generates less endogenous fluorescence of the samples observed.

In addition, the non-linear character of the absorption localizes the excitation, and therefore the emission of fluorophores, at the focal point of the laser in the sample to be studied. Thus, three-dimensional images of biological tissue in vivo can be obtained with a resolution on the order of the micrometer to depths of at least 500 μm, without causing damage to said tissue.

This non-linear character of the absorption also allows for fine three-dimensional spatial resolution.

In practice, the two-photon absorption observed for certain atoms or molecules has make it possible to develop numerous technologies in a wide variety of application fields, such as 3-dimensional microfabrication, optical data storage, photodynamic therapy and optical limitation (i.e. protection from laser aggression).

The development of TPEF has therefore paved the way for the development of effective processes and devices adapted to the living medium (and therefore called “biophotonic” processes and devices) in the field of cell imaging (microscopy, 3D imaging), in the field of diagnostic tools (fluorescent probes, absorbent particles, biochips), and in the field of therapy (phototherapy or photodynamic therapy).

However, it is noted that there is a lack on the market of fluorophore compounds specifically suitable for these new technologies.

Indeed, the fluorophore compounds currently used in the multiphoton techniques are optimized for the classic fluorescence techniques, i.e. implementing single-photon excitation.

These classic compounds of the prior art are not optimized for the multiphoton techniques and in particular not for biphotonic techniques.

In practice, these compounds have mediocre TPA properties in the spectral window of biological interest (700 to 1200 nm) and must be used at concentrations capable of disturbing the medium observed.

Thus, boron dipyrromethenes, commonly referred to in the literature as “BODIPY”, belong to a class of fluorescent chromophores having interesting properties: a photoluminescence “tunable” to wavelengths of 500-650 nm, i.e. the optimal working range for high-performing detectors (photomultipliers and avalanche photodiodes), a high fluorescence quantum efficiency in various media (including water in the case of water-soluble derivatives), and sufficiently long fluorescence decrease times (on the order of 4 to 5 ns). These compounds have therefore been used as fluorescent probes in a wide variety of applications, for example as cation sensors, as ionic fluorophores, and as dosimetric reagents, for controlling bioactivity (NO imaging), for imaging of living cells and even for immunofluorescence tests. However, these compounds, while having many advantages in terms of luminescence and solubility, have the major disadvantage of having very mediocre TPA performances, with effective two-photon absorption cross-sections less than or equal to 20 GM in the spectral range of biological interest. Therefore, they are not optimized for TPEF.

The main objective of the present invention is to propose new fluorescent compounds specifically suitable for implementation in biphotonic techniques.

In particular, an objective of this invention is to describe such compounds that make it possible to ensure the safety of the techniques in the context in which they are used, while having high sensitivity and selectivity.

In particular, an objective of this invention is to propose such compounds that have both a high fluorescent quantum efficiency in a variety of media (including water in the case of water-soluble derivatives), optimized effective TPA cross-sections (σ₂), i.e. with a two-photon absorption cross-section greater than 100 GM for at least one wavelength located in the spectral range of biological interest (700-1200 nm), high fluorescence decrease times, good photostability and low toxicity, in particular a low phototoxicity.

Another objective of this invention is to propose an array of such fluorescent compounds capable of being used on very different targets.

Yet another objective of this invention is to propose such compounds capable of producing light signals distinguishable by their emission wavelengths and thus allowing the implementation of multiplexing (the light flow emanating from the sample marked by a plurality of fluorophores can thus simultaneously transport a plurality of signals separable by filters).

A high effective TPA cross-section makes it possible to reduce the fluorescent molecular marker concentration and/or the excitation intensity, which is highly desirable for biological imaging.

These objectives are achieved by the invention, which relates to any chemical compound characterized in that it consists of a core having two-photon absorption properties bound by distinct covalent bonds to at least two boron dipyrromethene emitters with the formula (—BDP):

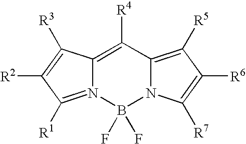

in which one of R¹ to R⁷ represents a covalent bond with said core, the others are identical or different, each designating a radical chosen from the group consisting of hydrogen, C₁ to C₂₅ alkyl radicals (sometimes denoted “Alk” in the rest of the description), preferably C₁ to C₁₂ alkyl radicals, (CH₂)ₘ—SO₃M, (CH₂)ₘNAlk₃⁺, (CH₂)ₘ—(OCH₂—CH₂)ₚ—OH, with M being an alkaline metal and m being equal to 0 or being an integer between 1 and 12, preferably between 1 and 6, and p being an integer between 1 and 25, aryl radicals (sometimes designated “Ar” in the rest of the description), heteroaryls, arylethenyl or arylethynyl. In the present description, the term “aryl radicals” refers to mono, bi or tricyclic aromatic hydrocarbon radicals with 6 to 14 carbon atoms, preferably phenyl, naphthyl, anthryl, fluorenyl radicals, and the term “heteroaryl radicals” refers to aromatic radicals including one or more heteroatoms, preferably pyridyl, quinoleinyl, thienyl, furyl or pyrrolyl radicals.

The compounds according to the present invention therefore consist of a core, of which the spectral characteristics enable the absorption of two photons and thus form a “two-photon antenna”, bound to at least two emitting components located at the periphery, of the boron dipyrromethene type (—BDP), capable of providing “tunable” luminescence properties.

The compounds according to the invention constitute systems of which the size varies according to the nature of the core and the emitting components as well as according to the number of the latter.

The compounds according to the present invention have the advantage of allowing a “decoupling” of the two-photon absorption and the emission. Thus, it is possible to overcome the strict constraints associated with the interrelationships between absorption and emission in systems in which the absorption is exclusively ensured by the emitting group.

The compounds according to the present invention make it possible to take advantage of the luminescence qualities (high fluorescence quantum efficiency, tunability, photostability) of the boron dipyrromethene type components patterns while having a very high effective two-photon absorption cross-section.

In the compounds according to the present invention, the core performing the role of biphotonic absorption is directly related to the emitting components.

It is also noted that the compounds according to the present invention do not use Förster energy transfer. Indeed, in the compounds of the invention, the absorption concerns the entire system (two-photon absorption core and emitters). This absorption involves excited states of increasing energy. That of the lowest energy (responsible for the single-photon absorption in the visible and the low two-photon absorption of BDP to 1000 nm) is located on the BDP emitters. The next states more specifically involve the two-photon absorption core. The rapid relaxation after excitation always brings it back to the excited state of the lowest energy responsible for emission. In the compounds of the invention, this state of lowest energy is located on the BDP-type emitting components. The emission therefore comes exclusively from the emitters and the emission characteristics of these BDP components are thus totally preserved. By contrast, the involvement in the absorption of excited states of higher energy (more specifically located on the cores) leads to two-photon absorption characteristics much more marked in the near IR. This approach makes it possible in particular to use two-photon absorption cores in which the extension of the conjugation or electronic delocalization makes it possible to significantly increase the absorption to one and two photons without causing a decrease in the natural fluorescence lifetime (Strickler-Berg law) because it comes exclusively from the BDP-type emitters.

The compounds according to the present invention therefore make it possible to entirely preserve the emission characteristics of the boron dipyrromethene type components while providing great chemical flexibility (via the choice of two-photon absorption cores) in order to amplify the two-photon absorption response of the systems. It is thus possible to adjust, according to requirements, the luminescence properties of the emitters while maintaining flexibility for the design of the two-photon absorption core.

Such an approach also provides great flexibility in terms of modulation of the luminescence properties (coverage of the visible spectrum via the “tuning” of the emitters), solubility (development of water-soluble derivatives and fluorescent compounds beneficial for biological imaging in particular).

According to a preferred alternative of the invention, each of said boron dipyrromethene emitters satisfies the formula (—BDP), in which R⁴ is a covalent bond.

As indicated above, one benefit of the present invention is that it provides great flexibility with regard to the design of the core forming the two-photon antenna.

The core can thus be chosen so that the compounds according to the present invention satisfy one of the following formulas.

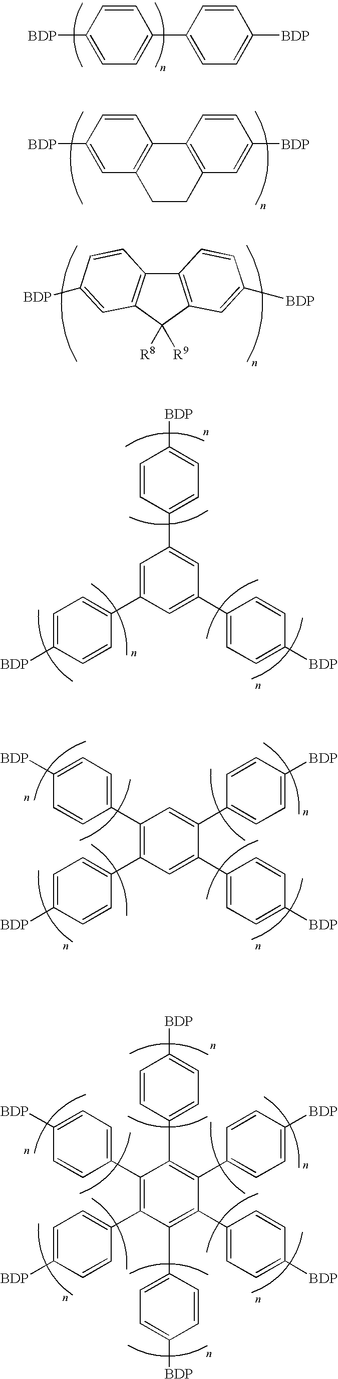

in which:

“BDP” represent identical boron dipyrromethene-type emitters as defined above:

n is an integer between 1 and 7;

R⁸ and R⁹ is, identical or different, designate a radical chosen from the group consisting of hydrogen, C₁ to C₂₅ linear or branched alkyl radicals, preferably C₁ to C₁₂ alkyl radicals, (CH₂)ₘ—SO₃M as well as their branched and polyanionic analogues, (CH₂)ₘNAlk₃⁺ as well as their branched and polycationic analogues, (CH₂)ₘ—(OCH₂—CH₂)ₚ—OH as well as their branched analogues, with M being an alkaline metal and m being equal to 0 or being an integer between 1 and 12, preferably between 1 and 6, and p being an integer between 1 and 25.

According to alternatives of the invention, the compounds satisfy one of the following formulas:

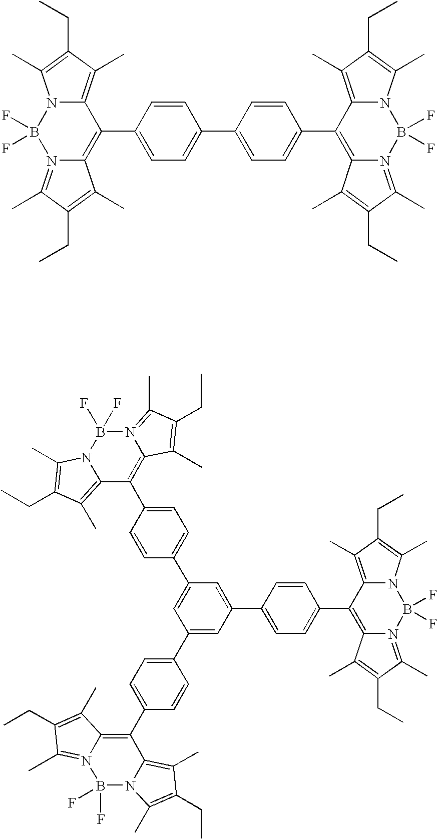

Also according to an alternative of the present invention, the compound satisfies the formula:

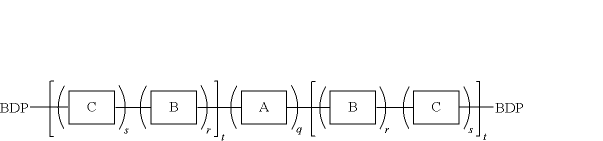

in which:

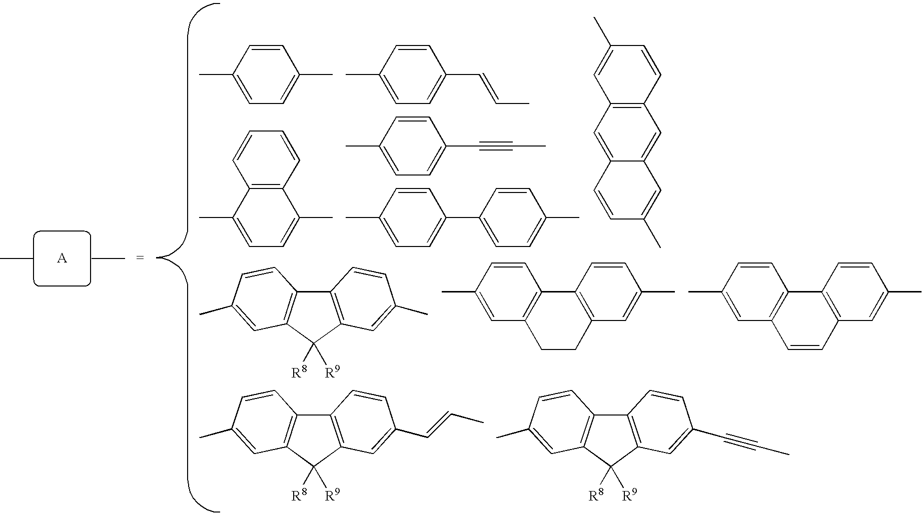

with R⁸ and R⁹ having the same meaning as above;

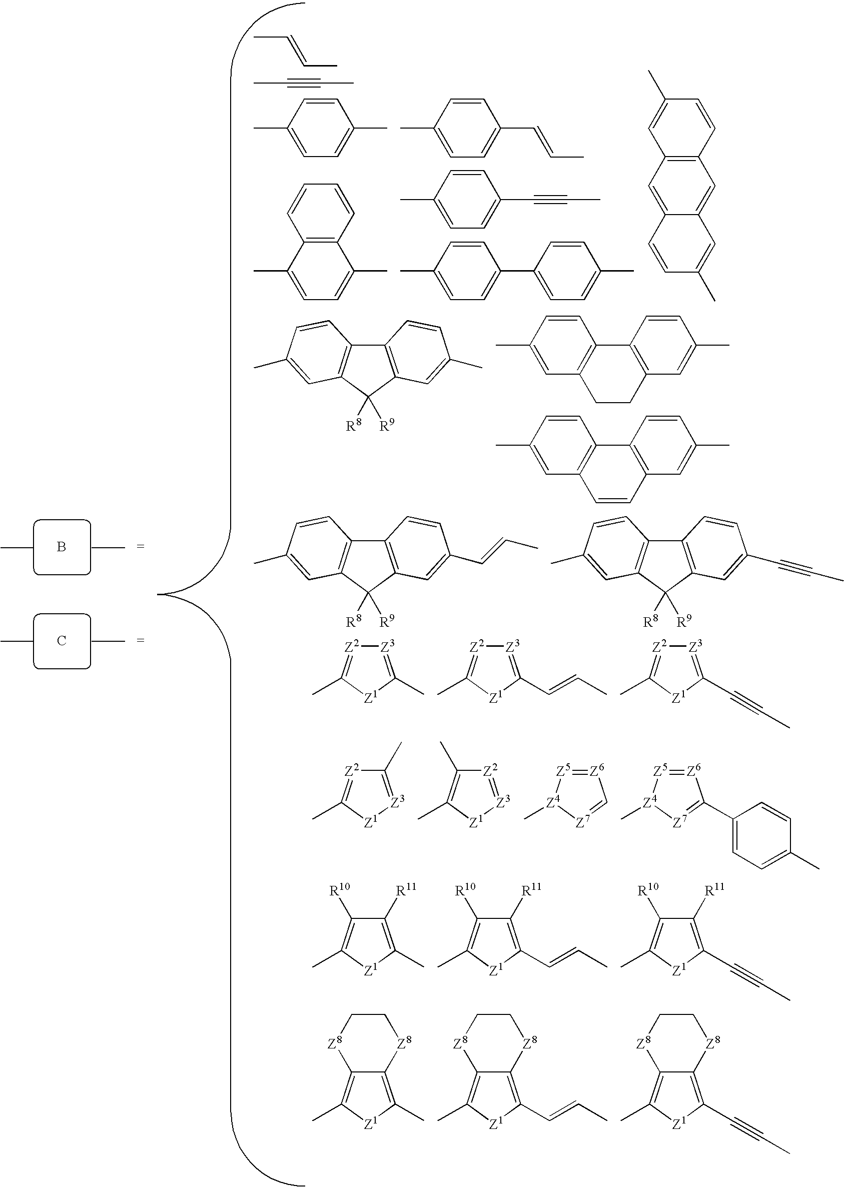

R¹⁰ and R¹¹, identical or different, each represent an OH, OAlk, Oar, SH, Salk or SAr radical;

Z¹ represents O, S, NH, NAlk, NAr, PH, PAlk or PAr;

Z² and Z³ each represent CH, CAlk or N;

Z⁴ represents N or P;

Z⁵, Z⁶ and Z⁷ each represent CH, CAlk or N;

Z⁸ represents O or S;

q is an integer between 1 and 7;

r is an integer between 1 and 7;

s is an integer between 0 and 7; and

t is an integer between 1 and 7.

According to another alternative of the invention, the compound satisfies the following formula:

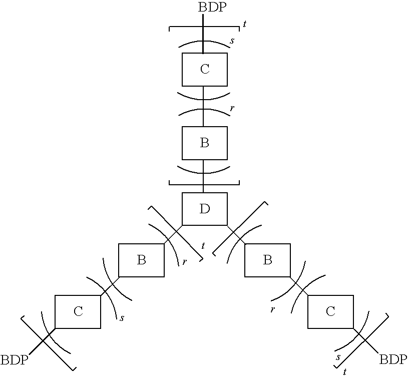

or the following formula:

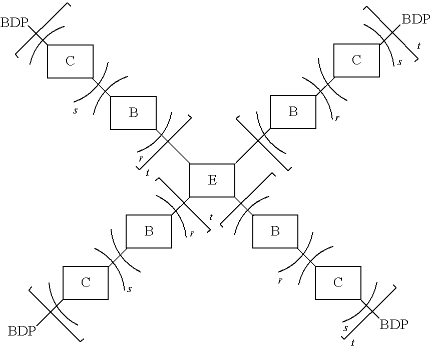

in which BDP, r, s, t

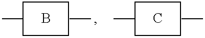

have the same meaning as above, and,

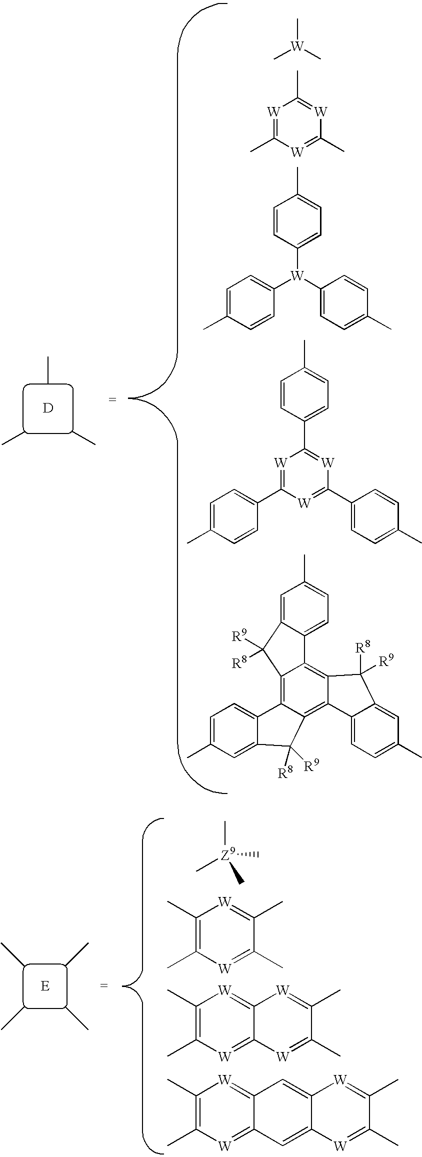

in which W is CH or B or N or P or PO;

R⁸ and R⁹ have the same meaning as above;

Z⁹ represents C, N⁺ or P⁺ or Si or Ge or Sn.

According to an alternative of the invention, a compound thus satisfies one of the following formulas:

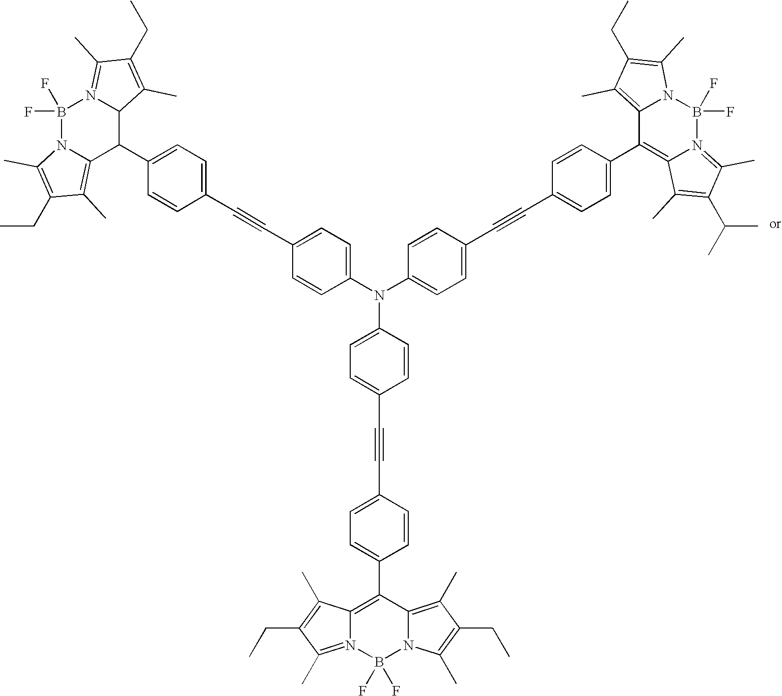

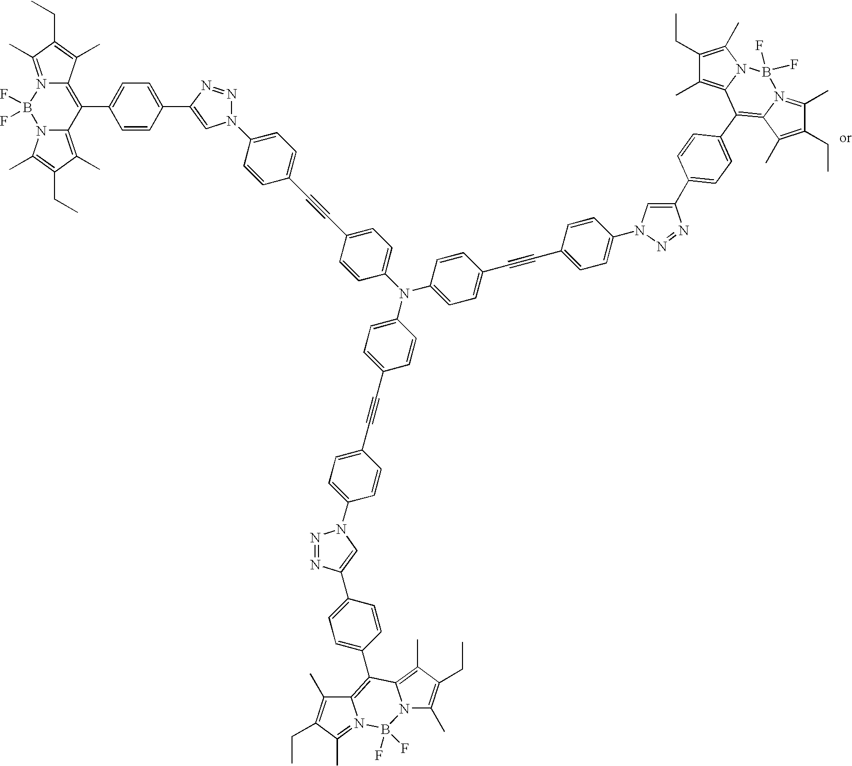

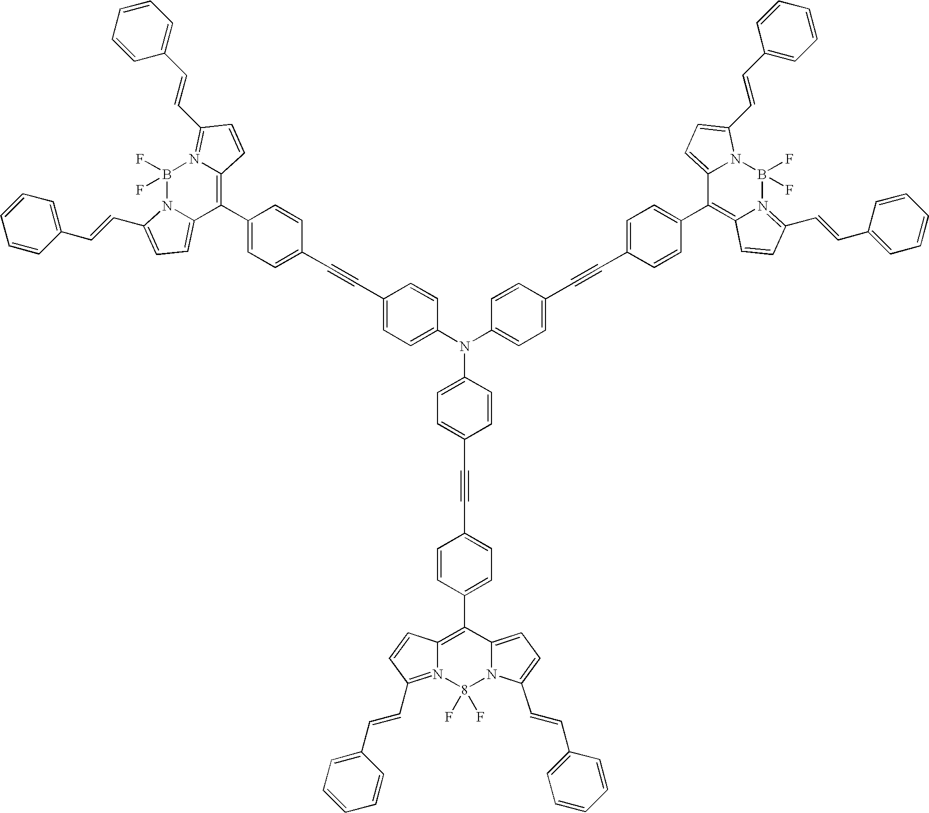

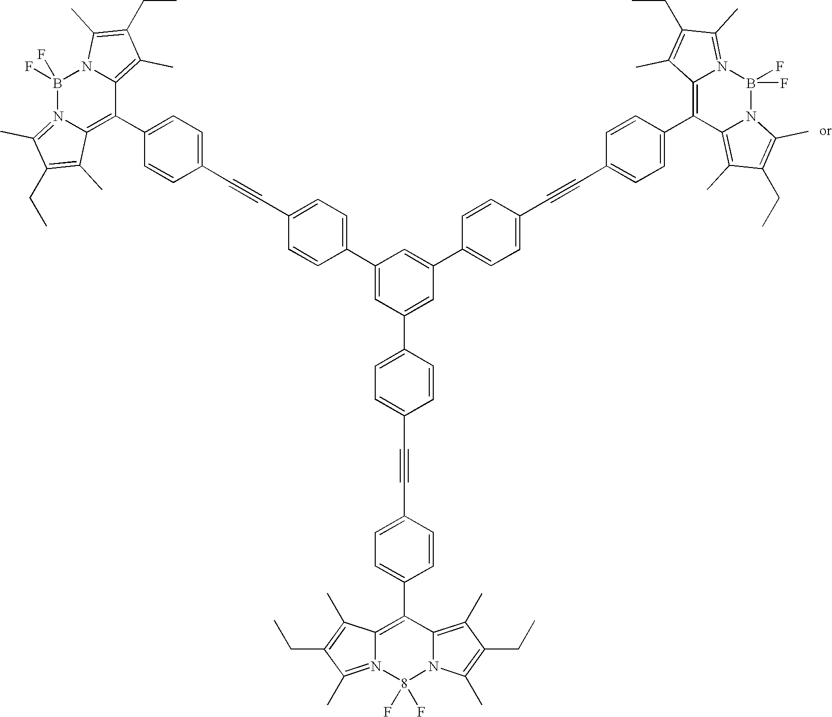

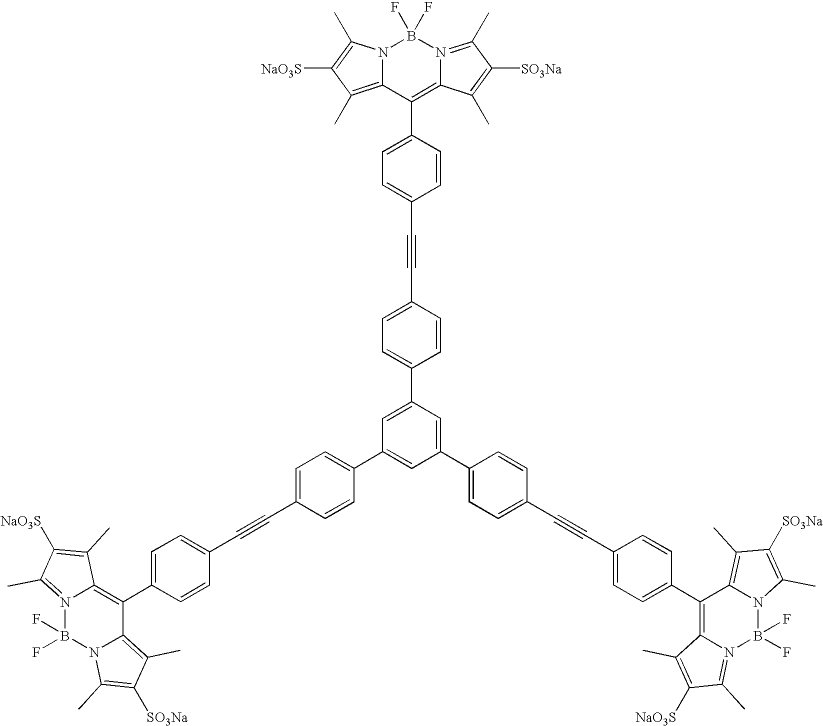

According to yet another alternative of the invention, the compound satisfies the following formula:

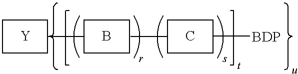

in which:

BDP,

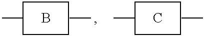

r, s and t have the same meaning as above;

u is equal to 2, 3, 4, 5 or 6; and

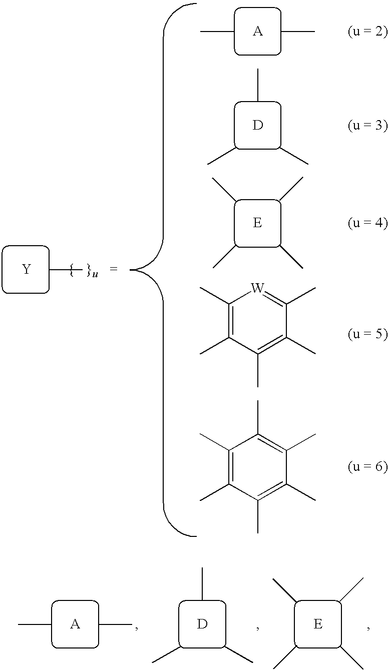

and W have the same meaning as above.

According to yet another alternative of the invention, the compound satisfies one of the following formulas:

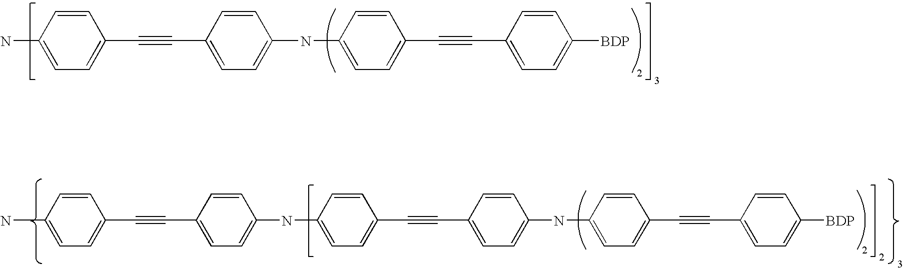

According to yet another alternative of the invention, the compound satisfies the following formula:

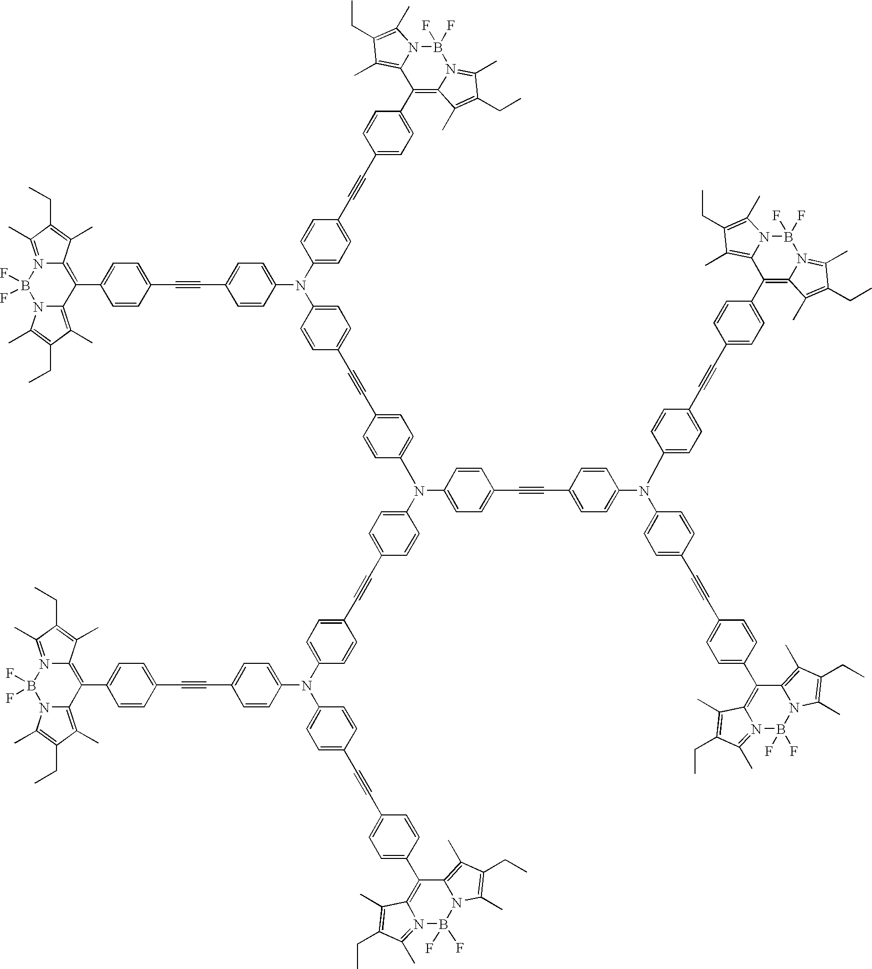

The invention also covers any use of such compounds in any process or device implementing a one- but preferably a two-photon or even a three-photon absorption, in particular in any biphotonic process or device.

Very specifically, the present invention covers any use of such compounds in a photon imaging process or a device.

The invention can be better understood in light of the following description of several non-limiting embodiments provided in reference to the figures, in which:

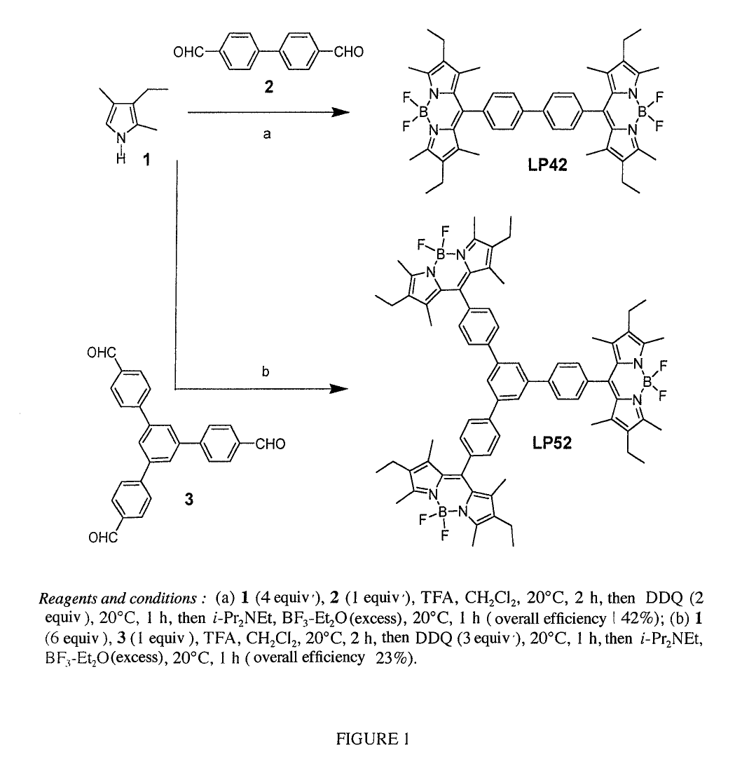

FIG. 1 shows the synthetic pathway of two compounds (LP42 and LP52) according to the present invention, with a biphenyl and a triphenylbenzene core, respectively;

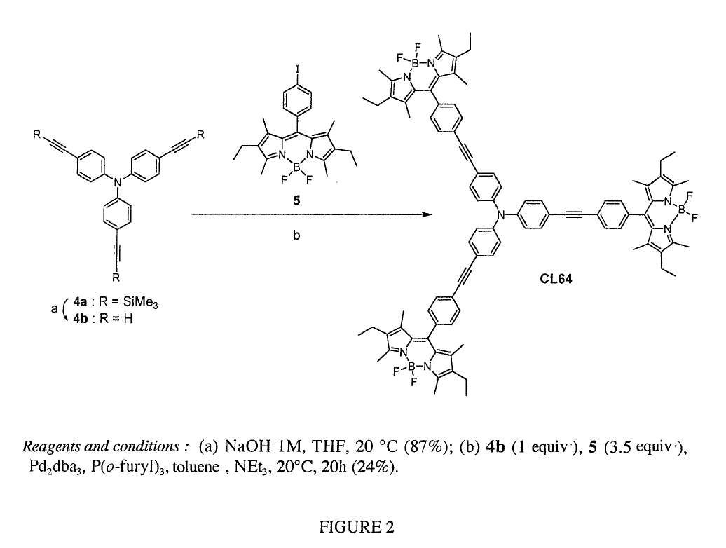

FIG. 2 shows the synthetic pathway of a third compound (CL64) with a triphenylamine core;

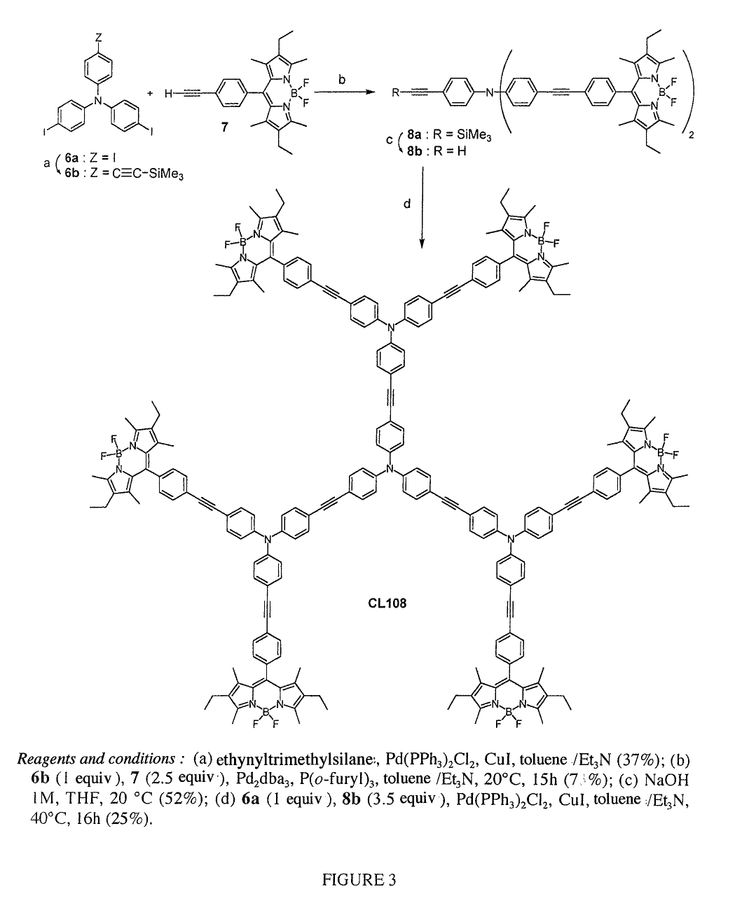

FIG. 3 shows the synthetic pathway of a fourth compound (CL108) with a dendrimer core;

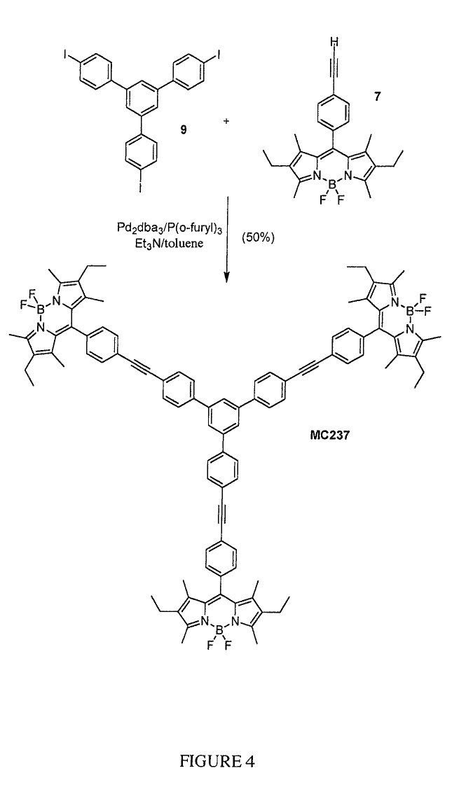

FIG. 4 shows the synthetic pathway of a fifth compound (MC237) according to the invention, of which the triphenylbenzene core is connected to three boron dipyrromethene emitters by means of phenylene-ethynylene-type spacers;

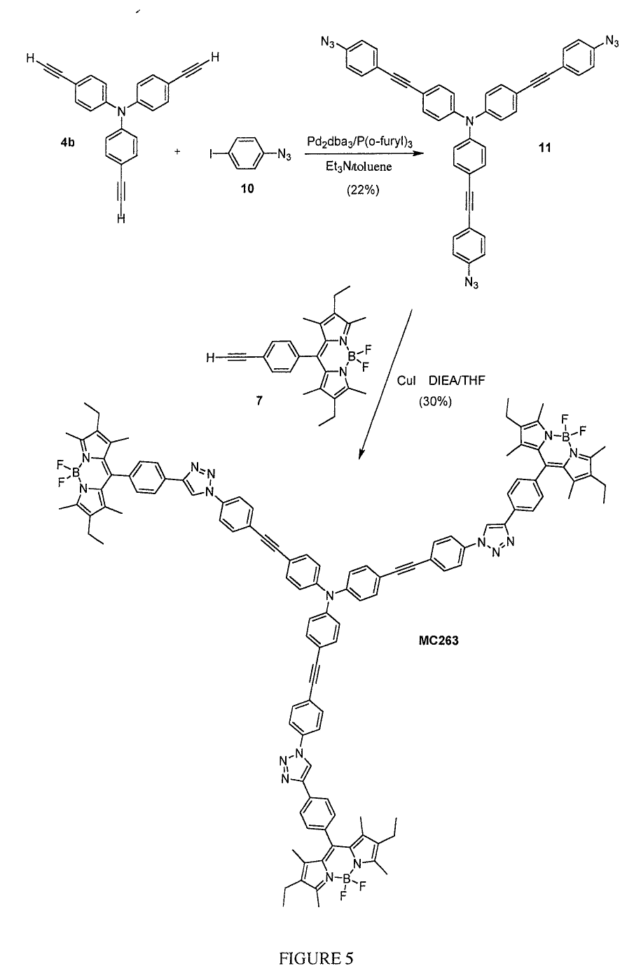

FIG. 5 shows the synthetic pathway of a sixth compound (MC263) according to the invention, of which the triphenylamine core is connected to three boron dipyrromethene emitters by means of spacers containing a triazole heterocycle;

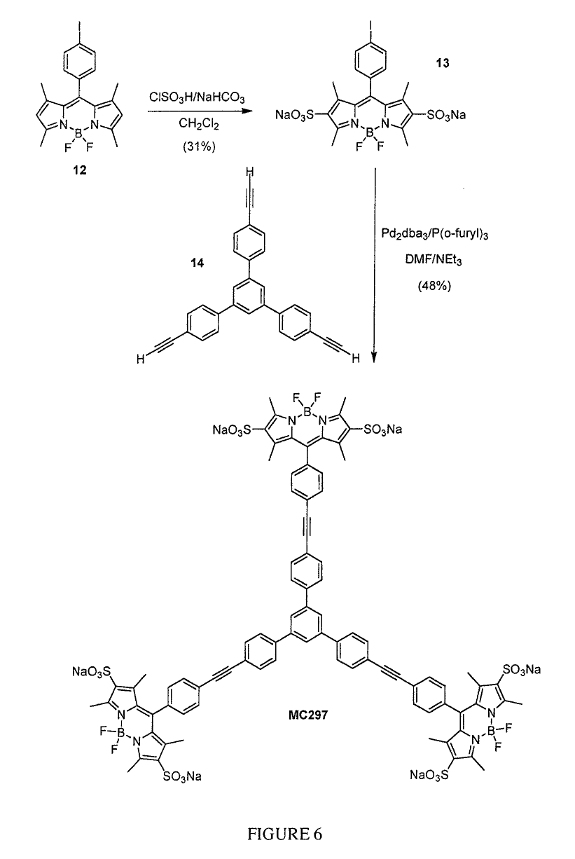

FIG. 6 shows the synthetic pathway of a compound (MC297) according to the invention, which is perfectly water-soluble;

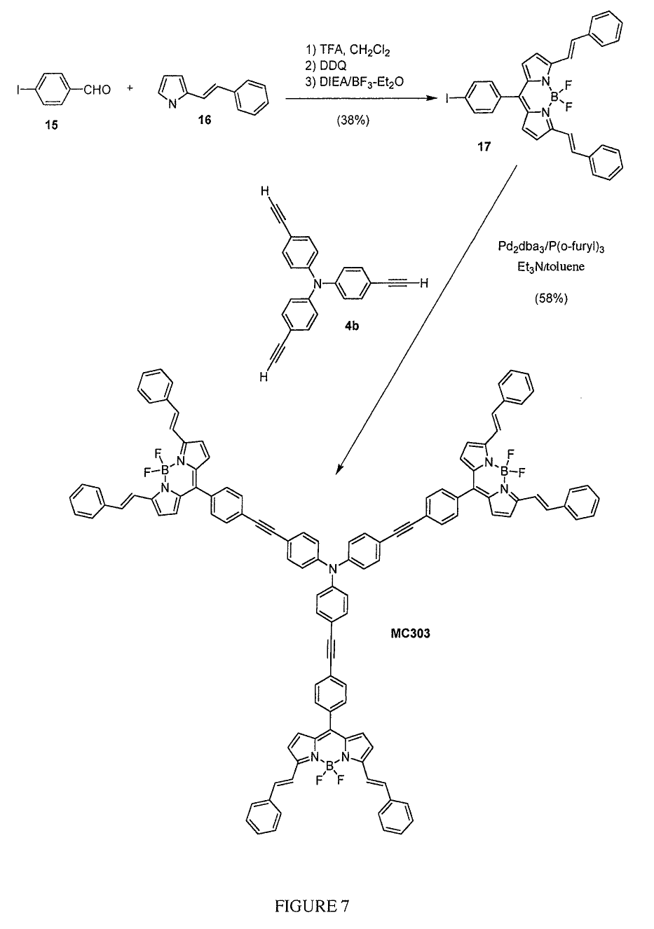

FIG. 7 shows the synthetic pathway of a compound (MC303) according to the invention, which emits red fluorescence;

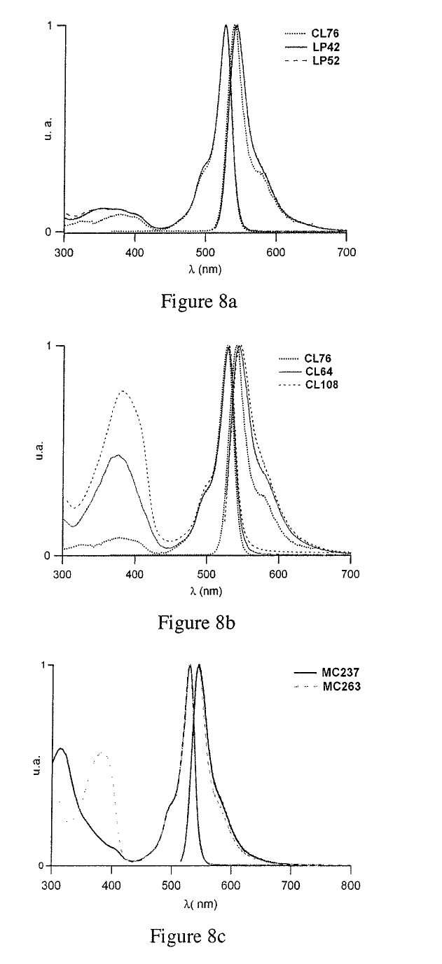

FIGS. 8a, 8b and 8c show the absorption and emission spectra, respectively, of compounds LP42, LP52, CL64, CL108, MC237 and MC263 as well as a compound of the prior art (CL76);

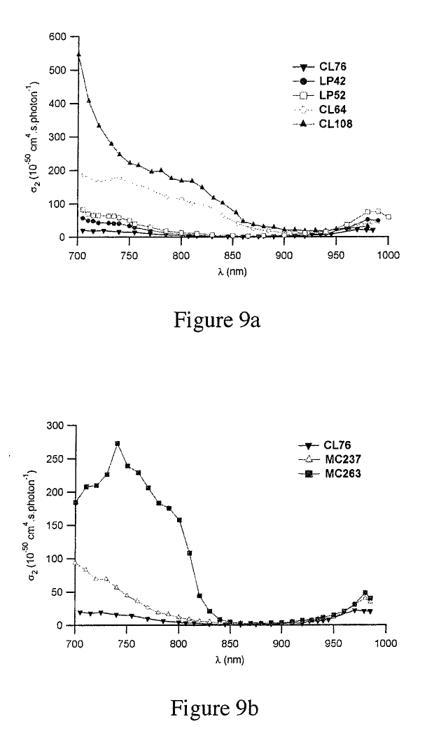

FIGS. 9a and 9b show the two-photon absorption spectra in the toluene of these seven compounds.

### Synthesis of tetrafluoro[1-[2,2′-[(1,1′-biphenyl)-4,4′-diylbis[[4-ethyl-3,5-dimethyl-2H-pyrrol-2-ylidene-]methylene]]bis[4-ethyl-3,5-dimethyl-1H-pyrrolato]]]diboron (LP42)

In reference to FIG. 1, this compound was synthesized from (1,1′-biphenyl)-4,4′-dicarboxaldehyde (2) and 4 equivalents of 2,4-dimethyl-3-ethylpyrrole (1) according to diagram 1 below. Its synthesis requires three steps: first, the addition of trifluoroacetic acid (TFA) to the aldehyde and pyrrole mixture in order to produce the corresponding dipyrromethane in situ, then the conversion of the latter into dipyromethene by oxidation with DDQ, and finally the treatment with an excess of BF₃-Et₂O in the presence of a base in order to obtain the corresponding boron complex.

More specifically, a drop of trifluoroacetic acid is added to a solution of 2,4-dimethyl-3-ethylpyrrole (367.4 mg, 3 mmol) and 4,4′-biphenyldicarboxaldehyde (158 mg, 0.75 mmol) in anhydrous dichloromethane (95 mL). The mixture is agitated for 2 h and a DDQ solution (340.5 mg, 1.5 mmol) in anhydrous dichloromethane (45 mL) is added. After 1 h of agitation, diisopropylethylamine (3 mL, 17.2 mmol), then BF₃-Et₂O (3 mL, 23.7 mmol) are added. The solution is agitated for 1 h and water (100 mL) is added. After filtration of the organic phase on silica, the solvent is evaporated and the product is purified by chromatography in a silica column (heptane/CH₂Cl₂ 3:2), to produce 240 mg (42%) of LP42.

### Synthesis of hexafluoro[μ₃-[2,2′2″-[1,3,5-benzenetriyltris[4,1-phenylene[[4-ethyl-3,5-dimethyl-2H-pyrrol-2-ylidene]methylene]]tris[4-ethyl-3,5-dimethyl-1H-pyrrolato]]]]triboron (LP52)

Also in reference to FIG. 1, this compound was prepared by reacting the trialdehyde 3 with 6 equivalents of pyrrole 1 using the same procedure as for LP42.

More specifically, two drops of trifluoroacetic acid are added to a solution of 2,4-dimethyl-3-ethylpyrrole (491.5 mg, 4 mmol) and 1,3,5-tris(4-formylphenyl)benzene (261.8 mg, 0.67 mmol) in anhydrous dichloromethane (95 mL). The mixture is agitated for 2 h and a DDQ solution (457 mg, 2 mmol) in anhydrous dichloromethane (50 mL) is added. After 1 h of agitation, diisopropylethylamine (4 mL, 22.9 mmol) and then BF₃-Et₂O (4 mL, 31.6 mmol) are added. The solution is agitated for 1 h and water (100 mL) is added. After filtration of the organic phase on silica, the solvent is evaporated and the product is purified by chromatography in a silica column (heptane/CH₂Cl₂ gradient, 1:1: to 0:1), to produce 185 mg (23%) of LP52.

### Synthesis of Compound CL64

In reference to FIG. 2, a third compound according to the present invention, arbitrarily called CL64, was also synthesized, according to diagram 2 below, by a Sonogashira triple coupling between trialkyne 4b (obtained by deprotection of 4a in a basic medium) and 3.5 equivalents of the iodized derivative 5.

More specifically, an aqueous solution of NaOH (1 M, 30 mL) is added to a solution of the compound 4a (2.33 g, 4.36 mmol) in THF (30 mL), and the mixture is agitated vigorously at 20° C. for 18 h. After evaporation of the THF, dichloromethane is added. The organic phase is separated, washed with water and dried (Na₂SO₄). The residue obtained after removal of the solvent is purified by chromatography on a silica column (heptane/CH₂Cl₂ 90:10, then 85:15) to produce 1.20 g (87%) of the compound 4b.

The air is purged with a solution of compound 4b (17.9 mg, 0.056 mmol), compound 5 (100 mg, 0.197 mmol) and tri-o-furylphosphine (0.52 mg, 2.26 μmol) in 1.5 mL of toluene/Et₃N (5/1) by argon bubbling for 30 min. Then, Pd₂ dba₃ (0.26 mg, 0.28 μmol) is added, and the mixture is agitated at 20° C. for 20 h. After evaporation of the solvent under reduced pressure, the raw product is purified by chromatography on a silica column (heptane/CH₂Cl₂ 60:40, then 50:50) to produce 19 mg (24%) of CL64.

### Synthesis of Compound CL108

In reference to FIG. 3, a fourth compound according to the present invention, arbitrarily called CL108 and having a dendrimer core was also synthesized, according to diagram 3 below.

More specifically, the compound N,N-bis(4-iodophenyl)-4-[(trimethylsilyl)ethynyl]benzenamine (6b) was first synthesized.

The air is purged from a solution of compound 6a (1.00 g, 1.605 mmol) in 8 ml of toluene/Et₃N (5/1) by argon bubbling for 20 min. Then, CuI (12 mg, 0.063 mmol), Pd(PPh₃)₂Cl₂ (22.5 mg, 0.032 mmol) and trimethylsilyacetylene (0.227 mL, 1.605 mmol) are added, and the mixture is agitated at 40° C. for 3 h. After evaporation of the solvent under reduced pressure, the raw product is purified by chromatography in a silica column (heptane) to produce 352 mg (37%) of compound 6b.

The dendron 8a was then produced.

The air is purged from a solution of compound 6b (200 mg, 0.337 mmol), compound 7 (341 mg, 0.843 mmol) and tri-o-furylphosphine (23 mg, 0.099 mmol) in 15 mL of toluene/Et₃N (5/1) by argon bubbling for 30 min. Then, Pd₂ dba₃ (12.3 mg, 0.013 mmol) is added, and the mixture is agitated at 20° C. for 15 h. After evaporation of the solvent under reduced pressure, the raw product is purified by chromatography on a silica column (heptane/CH₂Cl₂ 30:70) to produce 280 mg (73%) of the dendron 8a.

The dendron 8b was then synthesized.

To do this, an aqueous solution of NaOH (1 M, 50 mL) is added to a solution of compound 8a (200 mg, 0.174 mmol) in THF (75 mL), and the mixture is agitated vigorously at 20° C. for 24 h. Dichloromethane is added, then the organic phase is separated, washed with water and dried (Na₂SO₄). The residue obtained after removal of the solvent is purified by chromatography in a silica column (heptane/CH₂Cl₂ 25:75) to produce 98 mg (52%) of the dendron 8b.

Finally, the synthesis of compound CL108 is carried out according to the present invention.

To this end, the air was purged from a solution of compound 6a (11.1 mg, 17.8 μmol) and dendron 8b (67 mg, 62.4 μmol) in 1.8 mL of toluene/Et₃N (5/1) by argon bubbling for 25 min. Then, Pd(PPh₃)₂Cl₂ (0.50 mg, 0.71 μmol) and CuI (0.27 mg, 1.42 μmol) are added, and the mixture is agitated at 40° C. for 16 h. After evaporation of the solvent under reduced pressure, the raw product is purified by chromatography on a silica column (heptane/CH₂Cl₂ 20:80) to produce 15 mg (25%) of CL108.

### Synthesis of Compound MC237

In reference to FIG. 4, a fifth compound according to the present invention, arbitrarily called MC237 and having a dendrimer core was also synthesized, according to diagram 4 below.

The air is purged from a solution of 1,3,5-tris(4-iodophenyl)benzene (9) (50 mg, 0.073 mmol), 4,4-difluoro-8-(4′-ethynylphenyl)-1,3,5,7-tetramethyl-2,6-diethyl-4-bora-3a,4a-diaza-s-indacene (7) (103 mg, 0.256 mmol) and tri-2-furylphosphine (0.8 mg, 3.45 micromol) in 2.2 mL of toluene/Et₃N (5/1) by argon bubbling for 20 min. Then, tris(dibenzylideneacetone)-dipalladium (0) (4.0 mg, 4.37 micromol) is added and the mixture is agitated at 20° C. for 20 h. After evaporation of the solvent under reduced pressure, the raw product is purified by chromatography on a silica column (heptane/CH₂Cl₂ 70:30 then 50:50) to produce 55 mg (50%) of MC237.

### Synthesis of 4-[(4-azidophenyl)ethynyl]-N,N-bis[4-[(4-azidophenyl)ethynyl]phenyl]-benzenamine (11)

In reference to FIG. 5, this compound was synthesized, according to diagram 5 below.

The air is purged from a solution of 4-ethynyl-N,N-bis(4-ethynylphenyl)benzenamine (4b), (64 mg, 0.202 mmol), 1-azido-4-iodo-benzene (10) (197.6 mg, 0.807 mmol) and tri-2-furylphosphine (2 mg, 8.6 micromol) in 6 mL of toluene/Et₃N (5/1) by argon bubbling for 30 min. Then, tris(dibenzylideneacetone)-dipalladium (0) (11 mg, 12 micromol) is added and the mixture is agitated at 20° C. for 20 h. After evaporation of the solvent under reduced pressure, the raw product is purified by chromatography on a silica column (heptane/CH₂Cl₂ 80:20) to produce 30 mg (22%) of 11.

### Synthesis of Compound MC263

In reference to FIG. 5, a sixth compound according to the present invention, arbitrarily called MC263, was synthesized, according to diagram 6 below.

DIEA (0.2 mL) is added to a solution of 4-[(4-azidophenyl)ethynyl]-N,N-bis[4-[(4-azidophenyl)ethynyl]phenyl]-benzenamine (11) (27 mg, 0.040 mmol) and 4,4′-difluoro-8-(4′-ethynylphenyl)-1,3,5,7-tetramethyl-2,6-diethyl-4-bora-3a,4a-diaza-s-indacene (7) (57 mg, 0.141 mmol) in anhydrous THF (4 mL). The air is purged from the solution by argon bubbling for 20 min. Then, CuI (1.2 mg, 6.06 micromol) is added and the mixture is agitated at 35° C. for 16 h. After evaporation of the solvent under reduced pressure, the raw product is purified by chromatography on a silica column (heptane/CH₂Cl₂ 20:80, then 10:90) to produce 23 mg (30%) of MC263.

### Synthesis of 2,6-disulfonato-8-(4-iodophenyl)-1,3,5,7-tetramethyl-4-bora-3a,4a-diaza-s-indacene disodium salt (13)

In reference to FIG. 6, this compound was synthesized, according to diagram 6 below.

Chlorosulphonic acid (52 mg, 30 microL, 0.447 mmol) is added drop-by-drop at −10° C., under argon, to a solution of 1,3,5,7-tetramethyl-8-(4-iodophenyl)-4,4′-difluoroboradiazaindacene (12) (100.5 mg, 0.223 mmol) in 2.2 mL of dichloromethane. After 45 min, the reaction mixture is allowed to return to room temperature. The red solid obtained is isolated by vacuum filtration and washed with dichloromethane. Then, the precipitate is dissolved in water and the aqueous solution obtained is neutralized with sodium bicarbonate. After evaporation of the solvent under reduced pressure, ethanol is added and the yellow precipitate obtained is filtered. The solvent is evaporated and the raw product is purified by chromatography on a reverse-phase silica column (H₂O) to produce 40 mg (31%) of 13.

### Synthesis of compound MC297

In reference to FIG. 6, a seventh compound according to the present invention, arbitrarily called MC297, was synthesized according to diagram 6 below.

The air is purged from a 2,6-disulfonato-8-(4-iodophenyl)-1,3,5,7-tetramethyl-4-bora-3a,4a-diaza-s-indacene (13) (109.7 mg, 0.168 mmol), 4,4″-diethynyl-5′-(4-ethynylphenyl)-1,1′:3′,1″-terphenyl (14) (18 mg, 0.0479 mmol) and tri-2-furylphosphine disodium salt solution (0.2 mg, 0.86 micromol) in 1.8 mL of DMF/Et₃N (5/1) by argon bubbling for 20 min. Then, tris(dibenzylideneacetone)-dipalladium (0) (0.9 mg, 0.98 micromol) is added and the mixture is agitated at 20° C. for 60 h. The residue obtained after removal of the solvent under reduced pressure is purified by chromatography on a silica column (H₂O) to produce 45 mg (48%) MC297.

### Synthesis of 3,5-Bis((E)-2-phenylethenyl)-8-(4-iodophenyl)-4,4′-difluoroboradiazaindacene (17)

In reference to FIG. 7, this compound was synthesized, according to diagram 7 below.

Three drops of trifluoroacetic acid are added to a solution of 4-iodobenzaldehyde (15) (913 mg, 3.935 mmol) and 2-|(1E)-2-phenylethenyl|-1H-pyrrole (16) (333 mg, 1.968 mmol) in anhydrous CH₂Cl₂ (83 mL), under argon. The mixture is agitated for 5 h, then DDQ (447 mg, 1.968 mmol) is added and 15 minutes later, DIEA (3.56 g, 27.55 mmol) and BF₃-Et₂O (5.59 g, 39.36 mmol) are added. After 30 min, the mixture is washed with water, dried and the solvent is evaporated under reduced pressure. The residue is purified by chromatography on a silica column (heptane/CH₂Cl₂ 70:30) to produce 222 mg (38%) of 17.

### Synthesis of Compound MC303

In reference to FIG. 6, a seventh compound according to the present invention, arbitrarily called MC297, was synthesized according to diagram 6 below.

The air is purged from a solution of 3,5-bis((E)-2-phenylethenyl)-8-(4-iodophenyl)-4,4′-difluoroboroadiazaindacene (17) (105 mg, 0.176 mmol), 4-ethynyl-N,N-bis(4-ethynylphenyl)-benzenamine (4b) (15.9 mg, 0.050 mmol) and tri-2-furylphosphine (0.5 mg, 2.15 micromol) in 2 mL of toluelle/Et₃N (5/1) by argon bubbling for 20 min. Then, tris(dibenzylideneacetone)-dipalladium (0) (2.8 mg, 3.06 micromol) is added and the mixture is agitated at 20° C. for 15 h. After evaporation of the solvent under reduced pressure, the raw product is purified by chromatography on a silica column (heptane/CH₂Cl₂ 70:30, 50/50 then pule CH₂Cl₂) to produce 50 mg (58%) of MC303.

The absorption and photoluminescence characteristics of the 4 compounds of which the syntheses are described above were evaluated.

In this context, the absorption and fluorescence emission spectra of these compounds were obtained and are shown in FIGS. 8a, 8b and 8c.

In reference these figures, all of the compounds have, in toluene, a fine and intense absorption band at 527-528 nm, a characteristic of boron dipyrromethene chromophore.

The molar extinction coefficients increase with the increase in the number of boron dipyrromethene emitters. However, these compounds also have a second absorption band located between 300 and 400 nm. It is observed that this band is substantially broader and more intense for multichromophores LP42 and LP52 than for the model compound CL76 (|4-ethyl-2-|(4-ethyl-3,5-dimethyl-2H-pyrrol-2-ylidene)phenyl methyl|-3,5-dimethyl-1H-pyrrolato|difluoroboron, described in the article of Kollmannsberger et al., Angew. Chem., int. Ed. Engl. 1997, 36, 1333-1335). This band can be attributed to the absorption of the biphenyl and triphenylbenzene cores. With compound MC237, and even more with compounds CL64, MC263 and CL76, the second band increases significantly in intensity, in accordance with the increase in size of the antenna core; in parallel, the maximum of his second band is moved toward the red.

In emission, the compounds all have a single band, with similar widths and vibronic structures, with a maximum that varies very little (from 539 nm for model CL76 to 544 nm for compounds MC237 and CL108).

The TPA spectra of the four synthesized compounds (LP42, LP52, CL64, CL108, MC237 and MC263) as well as the reference boron dipyrromethene CL76 were also determined in the near-infrared (700-1000 in) by studying their two-photon excitation fluorescence (TPEF), and are shown in FIG. 9.

The measurements were taken in toluene solutions of 10⁻⁴ M, using a titanium-sapphire laser in locked mode generating pulses of ˜80 fs at 80 MHz.

The quadratic dependence of the fluorescence intensity with the excitation intensity was verified for each point of measurement. The calibration is done with respect to the effective TPEF cross-sections of the fluorescein in water (pH=11), which were determined absolutely in the former literature in the range of 690-1000 nm.

This method provides access to the effective TPEF cross-sections (σ₂φ), from which the corresponding effective TPA cross-sections (σ₂) are deduced. The values at 700 and 990 nm for the 4 synthesized compounds and for the reference compound are provided in Table 1 below. The data in the literature for compound PM556 are added for comparison.

In this table:

λ_{abs} represents the maximum absorption wavelength of the compound,

λₑₘ represents its maximum emission wavelength,

Φ represents its fluorescence quantum efficiency, determined with respect to the fluorescein in NaOH 0.1N, σ₂ represents its effective TPA cross-section (in GM, with 1 GM=10⁻⁵⁰ cm⁴.s.photon⁻¹); the TPEF measurements were performed with a titanium-sapphire laser in locked mode generating pulses of ˜80 fs at 80 MHz, by calibrating with fluorescein),

τ represents its fluorescence lifetime (also called the fluorescent decrease time).

TABLE 1

| | | | | | | σ₂ (GM) | |
|---|---|---|---|---|---|---|---|
| | | | | | | at | |
| | λ_{abs} | ε | λₑₘ | | τ | 700 | at 990 |
| Compound | (nm) | (M⁻¹ · cm⁻¹) | (nm) | Φ | (ns) | nm | nm |
| CL76^{a} | 527 | 76180 | 539 | 0.75 | | 20 | 20 |
| LP42^{a} | 527 | 161900 | 542 | 0.72 | 4.76 | 57 | 48 |
| LP52^{a} | 527 | 244300 | 542 | 0.69 | 4.78 | 82 | 75 |
| CL64^{a} | 528 | 221700 | 543 | 0.93 | 4.02 | 190 | 45 |
| CL108^{a} | 528 | 435000 | 544 | 0.67 | 3.17 | 545 | 31 |
| MC237^{a} | 528 | 216400 | 544 | 0.89 | 3.95 | 93 | 34 |
| MC263^{a} | 528 | 211100 | 542 | 1 | 4.36 | 185 | 40 |
| PM556^{b} | 491 | 98600 | 519 | 0.83 | 4.23 | — | 9 (20^{c})^{d} |

^{a}In toluene.
^{b}In water
^{c}effective TPA cross-section at 920 nm.
^{d}Data in the literature (Xu, C.; Webb, W.W. J. Opt. Soc. Am. B 1996, 13, 481-491).

The effective TPA cross-sections of compound LP42 and of compound LP52 are respectively 48 and 75 GM at 990 nm, which corresponds to 2.5 and 3.75 times greater than that of model CL76 at the same wavelength.

The invention therefore makes it possible to increase the effective cross-section of the maximum of the lowest energy.

With compounds CL64 and CL108, this maximum appears to shift toward the near-red (and therefore could not be determined).

More importantly, an even more marked increase is noted in the TPA band located in the region close to the red, confirming the involvement of excited states at a higher energy associated with the presence of the cores. Thus, at 700 nm, the effective cross-sections of LP42 and LP52 are respectively 3 and 4 times higher than that of the model CL76. With MC237, this effective cross-section is also 4 times higher than that of the CL76. This phenomenon further increases with the systems derived from triphenylamines CL64 and CL108, with effective TPA cross-sections at 700 nm, respectively 9 and 14 times higher than those of the model dipyrromethene CL76). The case of compound MC263, which has triazole heterocycles in each of its three branches, is also very interesting: its effective TPA cross-section at 700 nm is substantially the same as that of CL64, but the maximum of this band is shifted toward the large wavelengths with an effective cross-section reaching 270 GM to 750 nm (compared with 15 GM for the model compound CL76 at the same wavelength, i.e. a ratio of 18 to 1). The invention therefore makes it possible to modulate the position of this two-photon absorption band.

It is observed that the fluorescence quantum efficiencies and lifetimes vary little from one compound according to the invention to another. This demonstrates that the excitation energy is localized on the boron dipyrromethene patterns and that the emission takes place from these units, which makes it possible to preserve their excellent photoluminescence properties.

A marked widening of the higher-energy band toward the near-infrared (up to more than 850 nm) is observed with compounds CL64, CL108 and MC237, which has the effect of broadening the TPA activity range of these systems as can be seen in FIG. 2.

This higher-energy excitation band, responsible for the TPA excitement between 700 and 850 nm, is closely related to the presence in the multichromophoric systems of a core acting as a two-photon antenna.

The multichromophoric approach based on the association of a plurality of boron dipyrromethene-type fluorophores with cores capable of exciting the two-photon absorption is therefore an effective strategy for the improvement of the TPA properties. This approach to new TPEF probes offers various advantages, since it makes it possible to preserve the excellent characteristics of fluorescence and robustness of the boron dipyrromethenes, while taking advantage of the core-antennas in order to excite and modulate the TPA.

1. Chemical compound having an effective two-photon absorption cross-section greater than 50 GM, and preferably greater than 100 GM for at least one wavelength located in the range 700-1200 nm, characterized in that it consists of a core having two-photon absorption properties bound by distinct covalent bonds to at least two boron dipyrromethene emitters with the formula (—BDP): 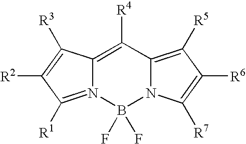
in which one of R¹ to R⁷ represents a covalent bond with said core, the others are identical or different, each designating a radical chosen from the group consisting of hydrogen, C₁ to C₂₅ alkyl radicals, preferably C₁ to C₁₂ alkyl radicals, (CH₂)ₘ—SO₃M, (CH₂)ₘNAlk₃⁺, (CH₂)ₘ—(OCH₂—CH₂)ₚ—OH, with M being an alkaline metal and m being equal to 0 or being an integer between 1 and 12, preferably between 1 and 6, and p being an integer between 1 and 25, aryl radicals, heteroaryls, arylethenyl or arylethynyl.

2. Compound according to claim 1, characterized in that each of said boron dipyrromethene emitters satisfies the formula (—BDP), in which R⁴ is a covalent bond.

3. Compound according to claim 1, characterized in that it satisfies one of the following formulas: 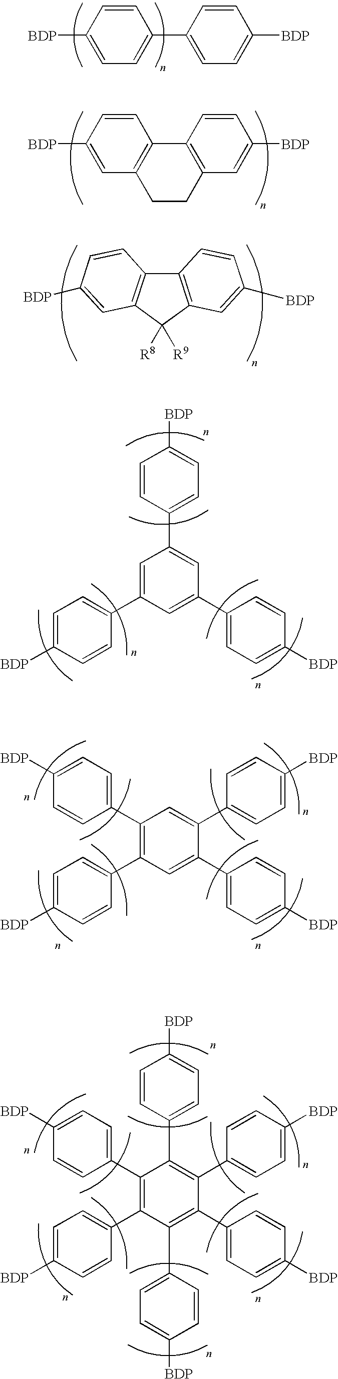
in which:
“BDP” represent identical boron dipyrromethene-type emitters satisfying the formula according to claim 1:
n is an integer between 1 and 7;
R⁸ and R⁹ is, identical or different, designate a radical chosen from the group consisting of hydrogen, C₁ to C₂₅ linear or branched alkyl radicals, preferably C₁ to C₁₂ alkyl radicals, (CH₂)ₘ—SO₃M as well as their branched and polyanionic analogues, (CH₂)ₘNAlk₃⁺ as well as their branched and polycationic analogues, (CH₂)ₘ—(OCH₂—CH₂)ₚ—OH as well as their branched analogues, with M being an alkaline metal and m being equal to 0 or being an integer between 1 and 12, preferentially between 1 and 6, and p being an integer between 1 and 25.

4. Compound according to claim 3, characterized in that it satisfies the following formula:

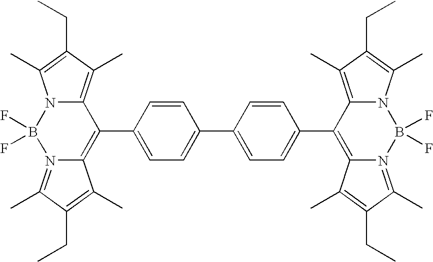

5. Compound according to claim 3, characterized in that it satisfies the following formula:

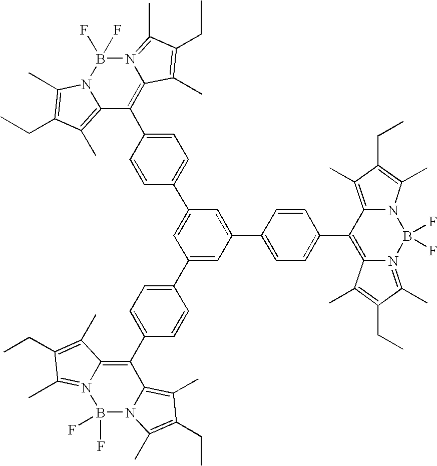

6. Compound according to claim 1, characterized in that it satisfies the following formula: 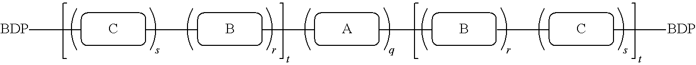
in which: 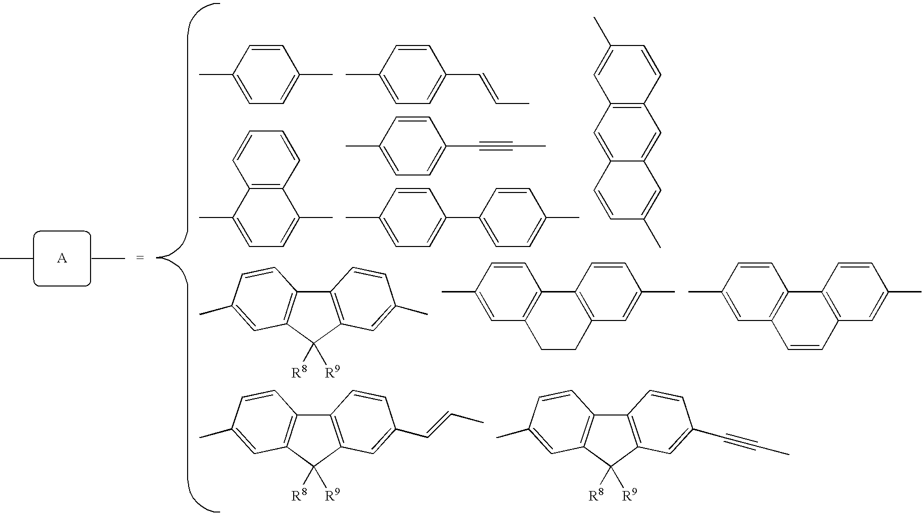 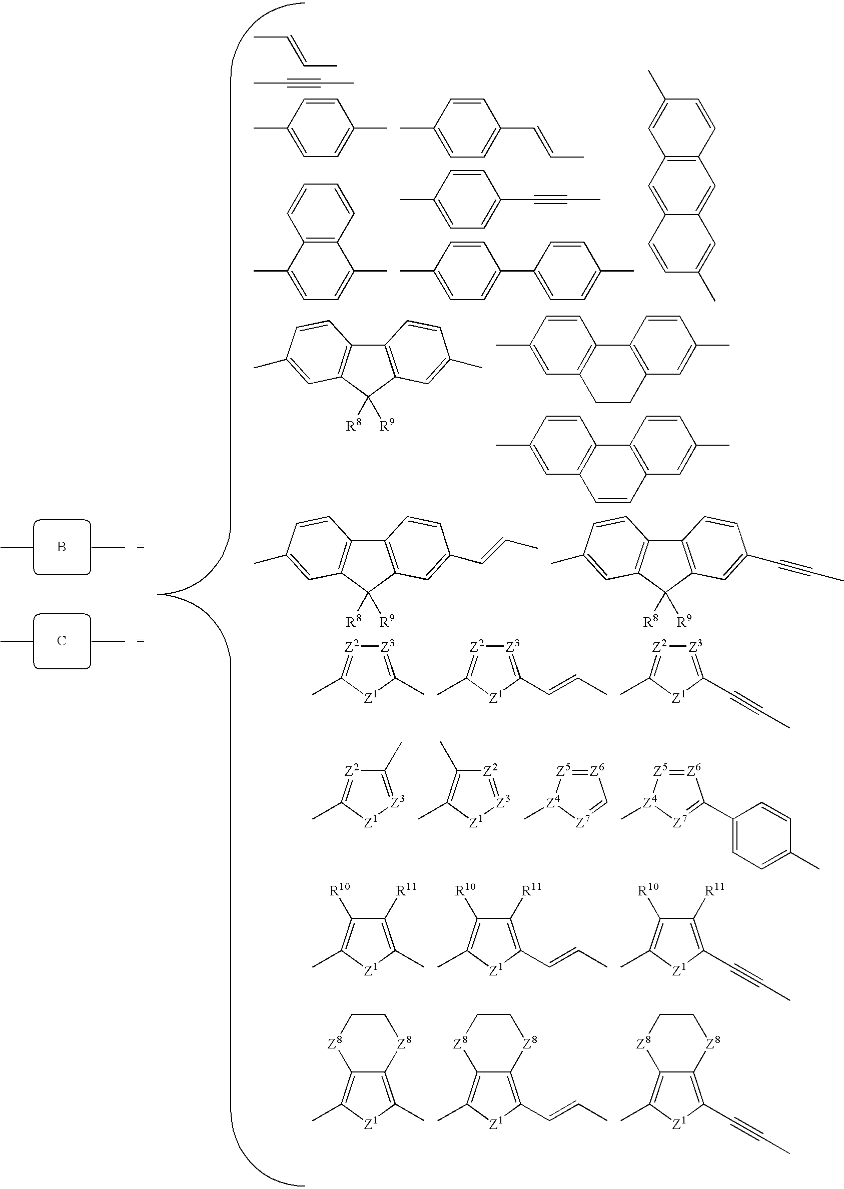
in which R⁸ and R⁹ have the same meaning as above;
R¹⁰ and R¹¹, identical or different, each represent an OH, OAlk, Oar, SH, Salk or SAr radical;
Z¹ represents O, S, NH, NAlk, NAr, PH, PAlk or PAr;
Z² and Z³ each represent CH, CAlk or N;
Z⁴ represents N or P;
Z⁵, Z⁶ and Z⁷ each represent CH, CAlk or N;
Z⁸ represents O or S;
q is an integer between 1 and 7;
r is an integer between 1 and 7;
s is an integer between 0 and 7; and
t is an integer between 1 and 7.

7. Compound according to claim 1, characterized in that it satisfies the following formula: 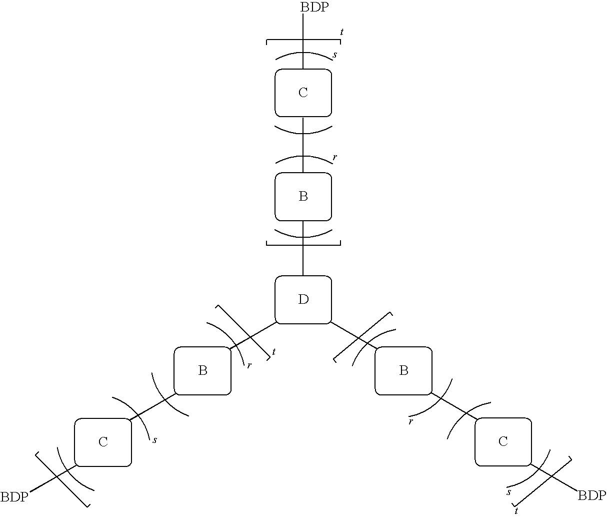
or the following formula: 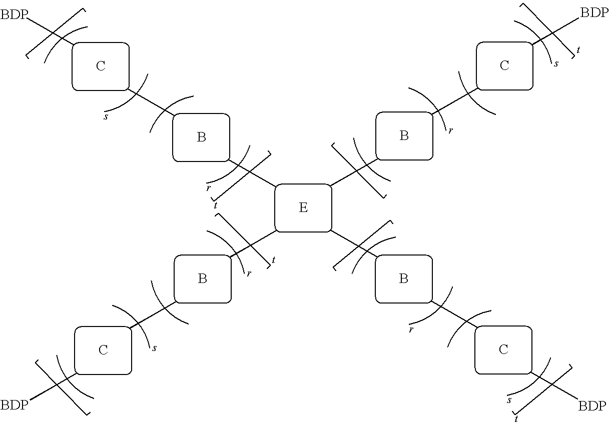
in which BDP, 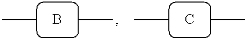
r, s, t have the same meaning as above, and, 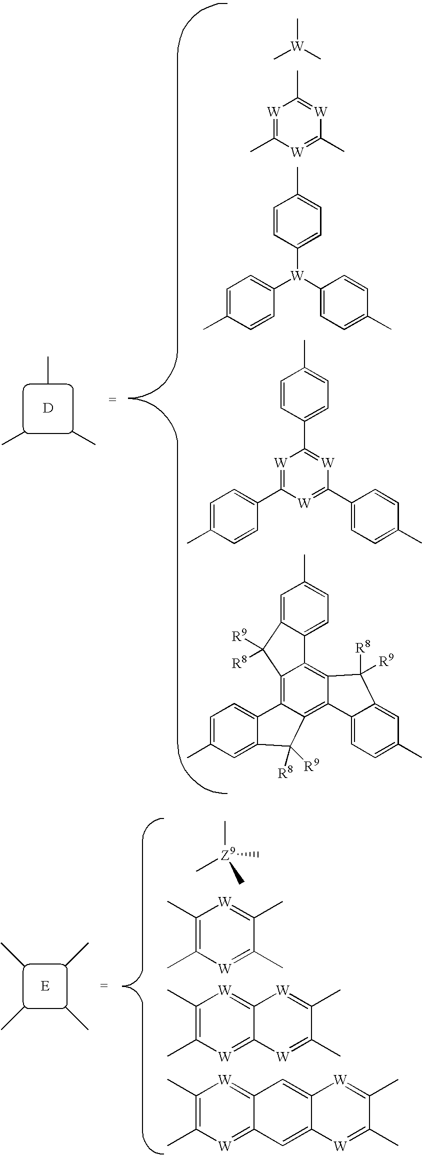
in which W is CH or B or N or P or PO;
R⁸ and R⁹ have the same meaning as above;
Z⁹ represents C, N⁺ or P⁺ or Si or Ge or Sn.

8. Compound according to claim 7, characterized in that it satisfies the formula:

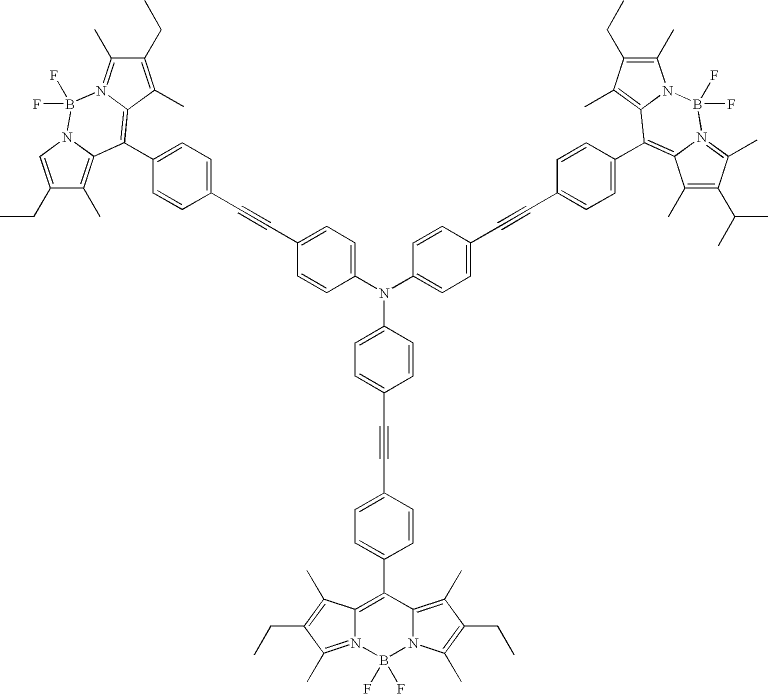

9. Compound according to claim 7, characterized in that it satisfies the formula:

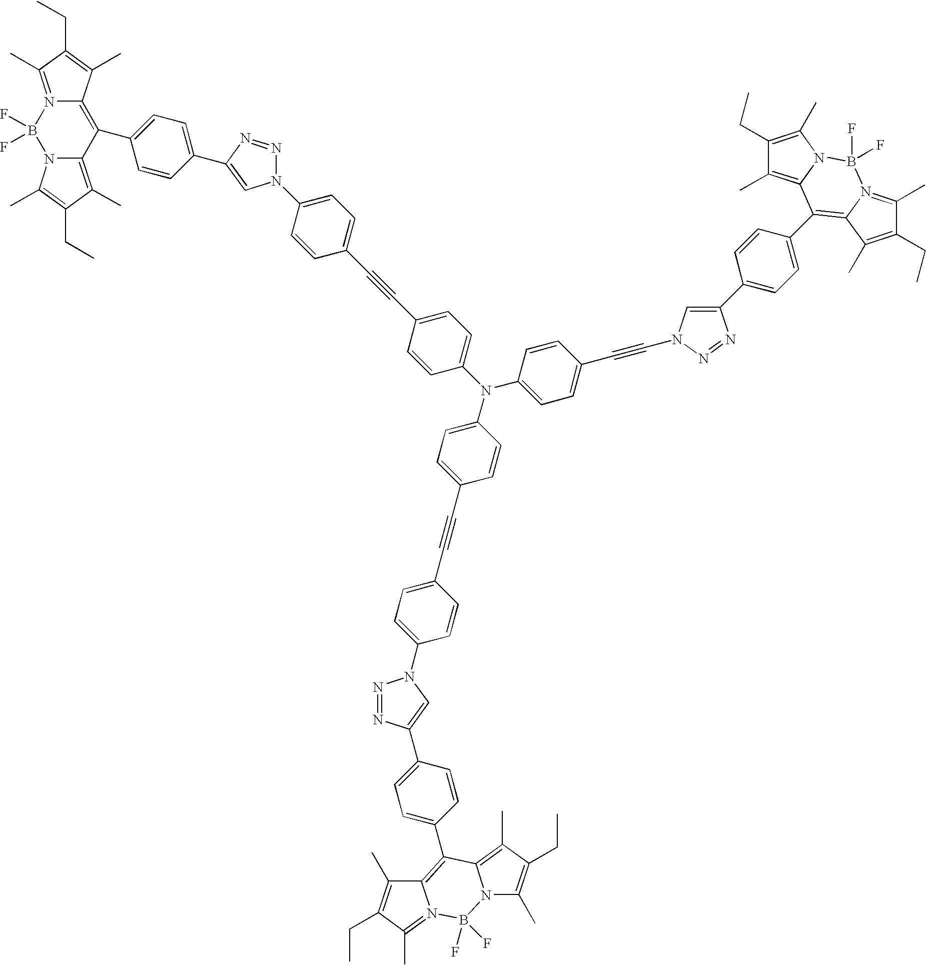

10. Compound according to claim 7, characterized in that it satisfies the formula:

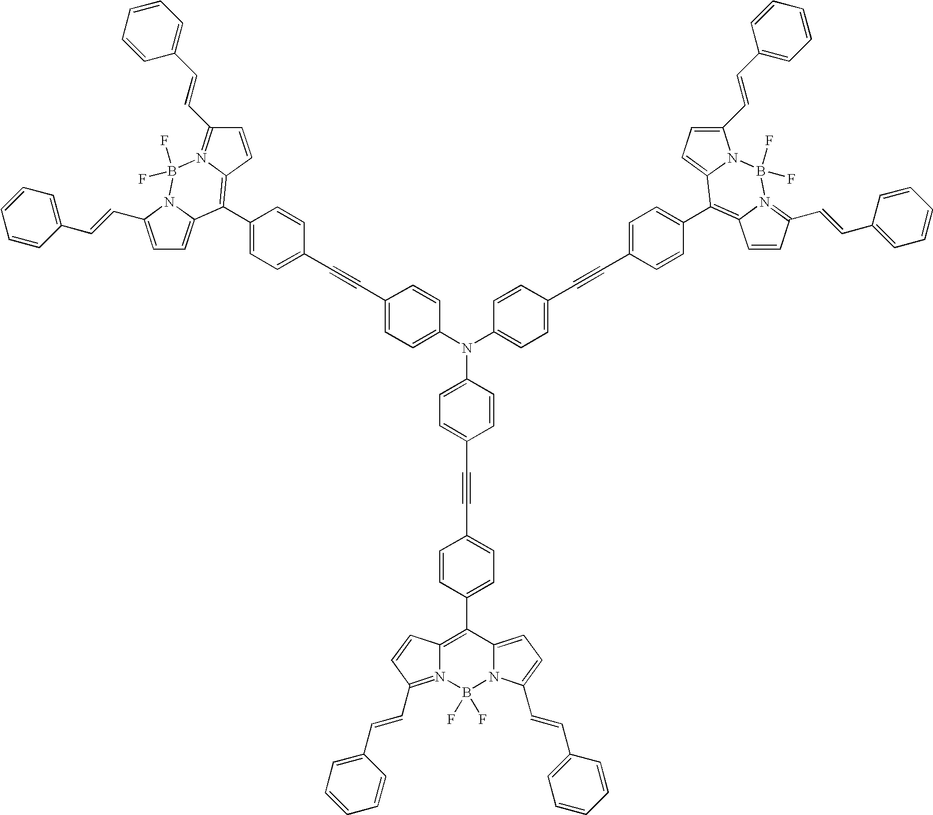

11. Compound according to claim 7, characterized in that it satisfies the formula:

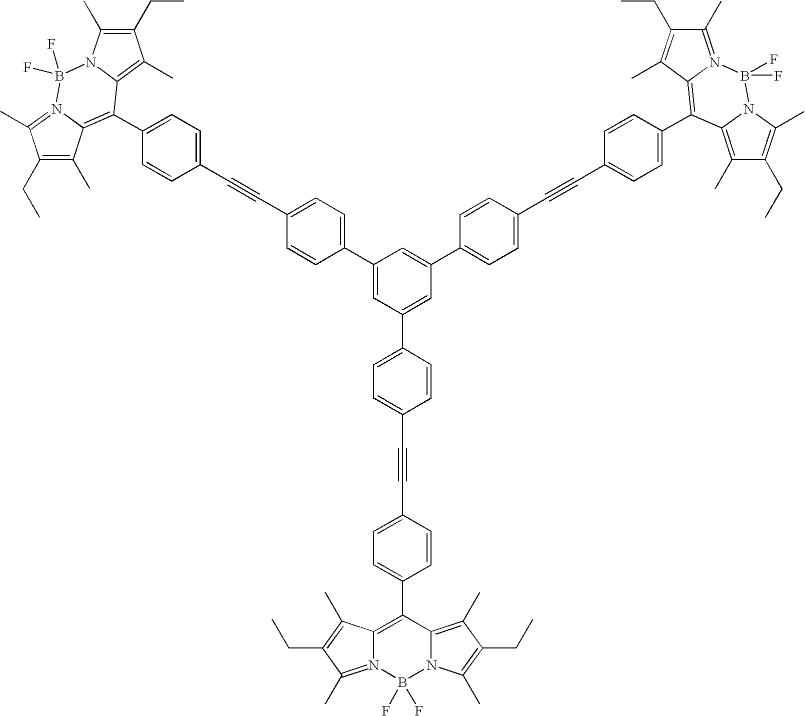

12. Compound according to claim 7, characterized in that it satisfies the formula:

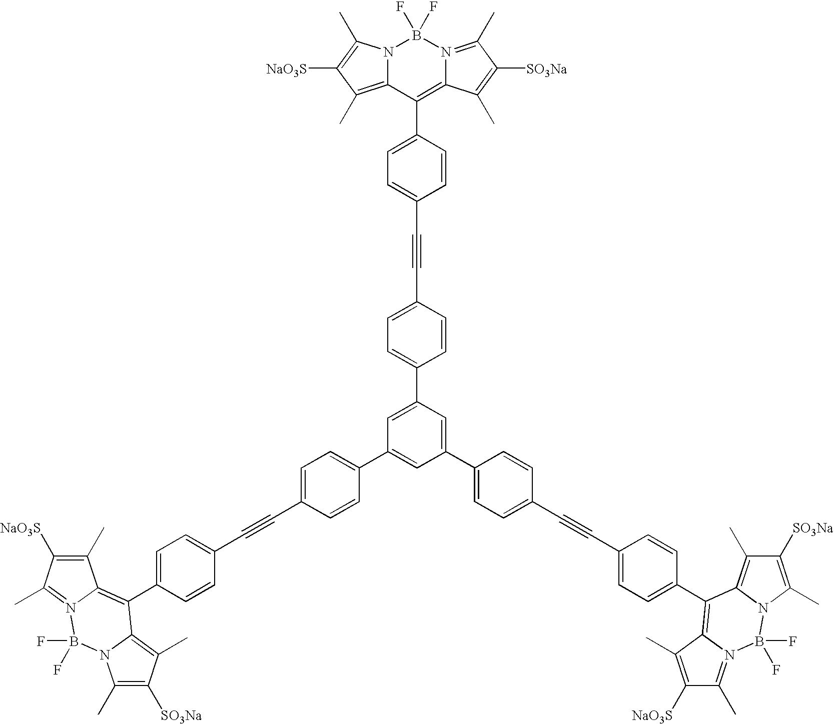

13. Compound according to claim 1, characterized in that it satisfies the following formula: 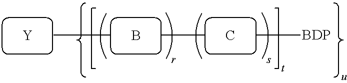
in which:
BDP, 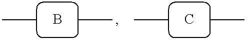
r, s and t have the same meaning as above;
u is equal to 2, 3, 4, 5 or 6; and 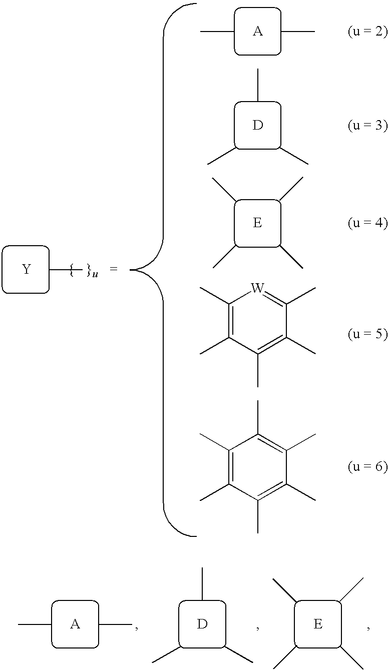
and W have the same meaning as above.

14. Compound according to claim 1, characterized in that it satisfies one of the following formulas:

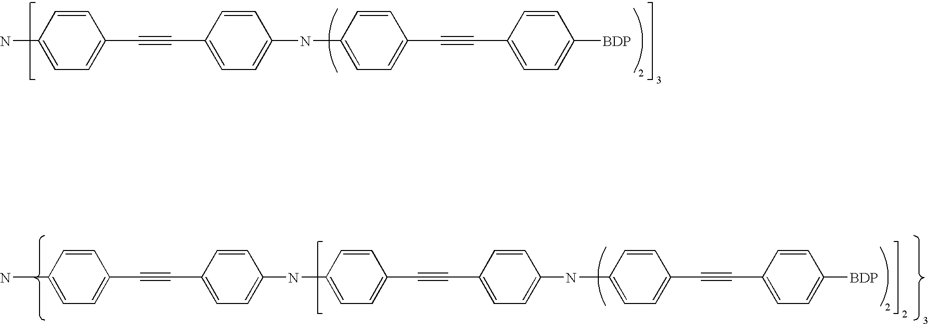

15. Compound according to claim 1, characterized in that it satisfies one of the following formulas: 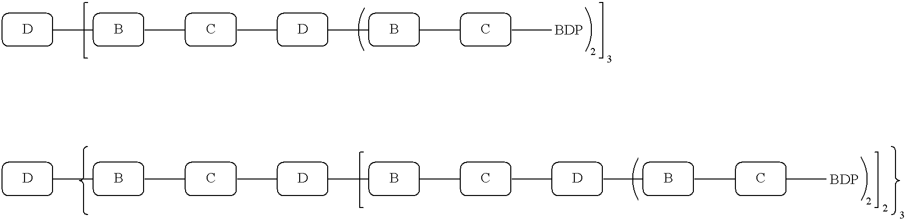
in which 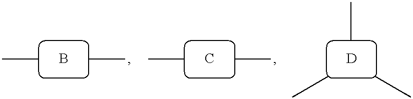
and BDP have the same meaning as above.

16. Compound according to claim 14, characterized in that it satisfies the formula:

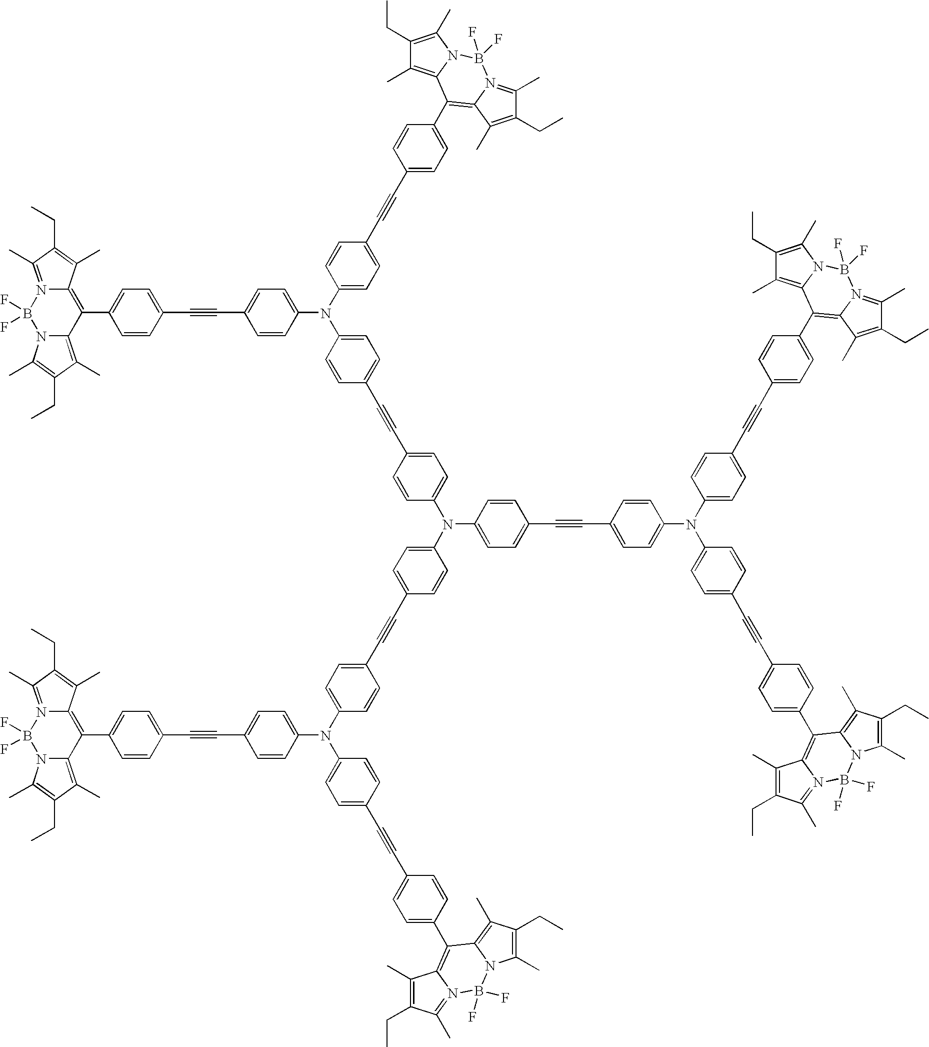

17. Use of a compound according to claim 1 in any process or device implementing a one- or a two-photon absorption.

18. Use according to claim 17 in the context of a biphotonic process or a biphotonic device.

19. Use according to claim 1 in the context of a photon imaging process or device.
